(19) United States
(12) Patent Application Publication
(10) Pub. No.: US 2004/0131084 A1
(43) Pub. Date: Jul. 8, 2004

(54) Parallel transmission of identical data to a plurality of terminals and feedback transmission of transmission quality information

(76) Inventors: Torsten Bing, Munchen (DE); Edgar Bolinth, Monchengaldbach (DE); Arndt Kadelka, Koln (DE); Andreas Kramling, Bonn (DE); Matthias Lott, Neuried (DE); Egon Schulz, Munchen (DE); Bernhard Wegmann, Holzkirchen (DE)

Correspondence Address: STAAS & HALSEY LLP, SUITE 700, 1201 NEW YORK AVENUE, N.W., WASHINGTON, DC, 20005, US

(21) Appl. No.: 10/466,359

(22) PCT Filed: Jan. 16, 2002
(86) PCT No.: PCT/DE02/00104

(30) Foreign Application Priority Data
Jan. 16, 2001 (DE) 101 01 741.3
Jan. 16, 2001 (EP) 01100915.6

(51) Int. Cl. H04J 3/24

(52) U.S. Cl. 370/473

(57) ABSTRACT

The invention relates to a method for the parallel transmission of identical data from a transmitter/receiver device to a plurality of terminals, said transmission at least partially proceeding via a radio connection. Common transmission capacities for a transmission of quality information regarding the transmission quality of the data are provided to the transmitter/receiver device in this radio connection for the purpose of transmission by a plurality of terminals.

The present invention relates to a method for the parallel transmission of identical data from a transmitter/receiver device to a plurality of terminals, with the transmission between the transmitter/receiver device and the terminals at least partially proceeding via a radio connection, as well as a radio communication system with at least one transmitter/receiver device and a plurality of terminals, which are configured to receive data, which is transmitted by the transmitter/receiver device via a radio connection.

A fundamental problem with the parallel transmission of identical data to a plurality of terminals—also referred to as distribution services such as Broadcast or Multicast—is guaranteeing the correctness of the transmitted messages. In particular in radio communication systems or communication systems in which a radio transmission takes place at least to some degree, there is a risk that data can be corrupted during transmission due to the properties of the radio connection or for example of a radio channel. With such systems considerable expenditure is required to ensure that all terminals have received the data to be transmitted correctly.

In particular with the multimedia services of the future, which may be based on the above methods and which are generally used simultaneously by a plurality of terminals, loss of data can be extremely critical. There is therefore a need for suitable measures, which guarantee that the data to be transmitted arrives securely and correctly at all terminals, with these measures always being applied, when the data is transmitted at least radio connection, which can cause incorrect data transmission.

In standard radio communication systems to date it is known for an error correction to be provided in the transmitter device (Forward Error Correction, FEC) as well as feedback transmission of quality information about the transmission quality of the transferred data, in particular in combination with a corresponding request for repeat transmission of the data (Automatic Repeat Request ARQ) in the case of data transmissions between a transmitter/receiver device and an individual terminal (Unicast connection) to guarantee that the data transmission is substantially correct. If FEC methods fail in the event of poor radio connection conditions (e.g. poor radio channel response such as fading) or a high level of interference, repeat transmission, for example controlled by an Automatic Repeat Request (ARQ), is highly likely to ensure that the data arrives correctly at the receiver terminal. An example of an ARQ method, in which quality information is defined for individual user data, is disclosed in EP 0 938 207.

If a data packet has been transmitted on the route from the transmitter/receiver device to the receiver terminal, for example on a logical connection, which exists in the case of a Unicast connection, and said data packet could not be received correctly at the receiver terminal, incorrect receipt is signaled by a negative acknowledgement on the return route from the receiver terminal to the transmitter/receiver device. The ARQ method then initiates the repeat transmission of the incorrectly transmitted data on the same logical connection.

In fixed networks FEC and ARQ methods are combined in currently known methods for the parallel transmission of identical data to a plurality of terminals—as with Multicast and Broadcast connections. To minimize the accumulation of data occurring at the terminals due to signaling packet data units (S-PDU), which transmit quality information for example in the form of acknowledgements, these acknowledgements are bundled at logical node points of the fixed network and forwarded from there to the transmitter/receiver device. Also node points, which have already received the data successfully, can retransmit the incorrectly transmitted data in a targeted manner to the receiver terminal instead of the transmitter/receiver device. These methods however cannot be used or can only be used in a restricted manner for communication systems with radio connections.

In communication systems with radio connections with the methods known to date for the parallel data transmission of identical data to a plurality of terminals—as with Multicast and Broadcast connections—only FEC methods with quite a high level of redundancy are used. This means that a correspondingly higher level of redundancy has to be added to the data to be transmitted for the purposes of error correction, which means a greater accumulation of data on the route from the transmitter/receiver device to the terminal. Other known methods of guaranteeing correct transmission are on the one hand the use of low-value modulation, for which a smaller signal/noise ratio is adequate, resulting in a lower incidence of error, or on the other hand a method, which provides in principle for the multiple transmission of data, but which results in multiplication of the data accumulation.

The feedback transmission of quality information about the transmission quality of the transmitted data, for example by means of ARQ methods, cannot be used with communication systems, which operate at least partially via a radio connection, in the context of the methods known to date. This is because the transmission capacity required for this would be too large on the route back from the receiver terminal to the transmitter/receiver device and for repeat transmissions with the methods known to date, as the probability of incorrect transmission increases as the number of terminals increases and a correspondingly large transmission capacity would have to be provided for the terminals for the feedback transmission of quality information. Provision of such a large transmission capacity is however not acceptable in view of the scant transmission capacity resources for radio connections.

It is therefore the object of the present invention to allow the most correct transmission possible of identical data to a plurality of terminals for communication systems with radio connections, with the smallest possible accumulation of data going from a transmitter/receiver device to the terminals and with no need for excessive transmission capacities going from the terminals to the transmitter/receiver device.

This object is achieved by means of the features in claims 1 and 14.

The invention comprises a method for the parallel transmission of identical data from a transmitter/receiver device to a plurality of terminals, with the transmission between the transmitter/receiver device and the terminals proceeding at least partially via a radio connection. The terminals here can be subscriber terminals for example, in other words communication terminals, with which a subscriber communicates with a device or another subscriber or on which said subscriber receives data, such as for example multimedia data. The terminals can however also be measuring, control or monitoring devices, which can be activated or interrogated by a transmitter/receiver device.

According to the invention quality information about the transmission quality of the data is transmitted back to the transmitter/receiver device from the terminals after receipt of the data, with common transmission capacities being made available to the terminals within the context of the radio connection for transmission of quality information from a plurality of terminals to the transmitter/receiver device.

Unlike the methods known to date from the prior art, provision is now made for quality information also to be transmitted back to the transmitter/receiver device in communication systems, in which a radio connection is set up parallel to a plurality of terminals. This means that an increased accumulation of data does not occur going from the transmitter/receiver device towards the terminals, as is required with the prior art by the FEC methods with a higher level of redundancy. Nor are excessive transmission capacities required in the direction of transmission from the terminals to the transmitter/receiver device, as there is provision for simultaneous transmission of the quality information, with access to common transmission capacities. These common transmission capacities can for example be an identical radio channel, an identical frequency of a frequency multiplex method, an identical time slot of a time multiplex method or an identical code of a code multiplex method or transmission capacities can be provided simultaneously in another way, such as for example by spatial separation measures.

If a plurality of terminals transmit quality information, these transmissions can occur at the same time in the common transmission capacity and can therefore even overlap each other. This is not a problem however, as in the simplest case it can even be adequate, when the information arrives at the transmitter/receiver device, for at least one of the terminals to have received certain data incorrectly. A repeat transmission of this data can then proceed on the basis of this information, in the above case for example to all terminals, if no more precise data can be extracted from the transmitted, possibly overlapping quality information, as to which of the terminals received the data incorrectly.

For this invention, there can be provision for quality information at least to be sent back to the transmitter/receiver device, if part of the data was transmitted incorrectly. In this case only a negative acknowledgement is given, in other words if the data was received correctly, there is no feedback to the transmitter/receiver device. The advantage of this method is that data accumulation is largely minimized.

There can however also be provision for quality information being sent back continuously from the terminal to the transmitter/receiver device after receipt of the data, said quality information containing information about which data was transmitted incorrectly and which correctly. A positive acknowledgement is then given in the case of correct transmission or a negative acknowledgement in the case of incorrect transmission of the data. The advantage of this method is that in every case there is clear information in the transmitter/receiver device about the transmission quality of the transmitted data. This clearly excludes the unwanted occurrence of a terminal sending back a negative acknowledgement that does not arrive at the transmitter/receiver device, with the result that correct data transmission is assumed.

The simultaneous use of common transmission capacities according to the invention can, as stated above, be facilitated in different ways. Provision can for example be made for the simultaneous transmission of quality information by spatial separation of the quality information sent back using spatially separating receiver components in the transmitter/receiver device.

Spatially separate terminals can for example use the same radio channel, without the data transmitted by them overlapping or causing mutual interference, as the data transmissions of the terminals are separated by the spatially separating effect of the receiver components. Specific examples of this are when spatial separation is achieved using sectorizing antennae or adaptive antennae as receiver components of a transmitter/receiver device.

An alternative option for the simultaneous use of common transmission capacities is for the simultaneous transmission of the quality information to be achieved by means of simultaneous access by the terminals to at least one common transmission unit of the radio connection to the transmitter/receiver device. At least one specific transmission unit for a radio connection to the transmitter/receiver device is then not made available to each terminal as was common practice but the terminals share at least one common transmission unit of a radio connection. This can in principle result in overlapping of the individual transmissions of quality information, if there is not a further separation of the individual items of information, as explained below. Simultaneous access to at least one common transmission unit can take the form of simultaneous access for example to at least one common frequency of a frequency multiplex radio connection, at least one common time slot of a time multiplex connection or at least one common code of a code multiplex connection.

If however all overlapping of the transmitted quality information is to be avoided, or if further information is to be transmitted, the information transmitted in the context of the transmission unit can be coded to identify the terminals and/or incorrectly transmitted data clearly. This coding can in particular be achieved by varying the physical properties, in particular the energy, frequency or duration of the carrier signals of the radio connection to the transmitter/receiver unit during the transmission unit. Such a coding can be specifically achieved in the context of multi-carrier methods such as OFDM, which use a plurality of carriers, in some cases also referred to as subcarriers, to transmit data during a transmission unit. Such an OFDM method for communication systems is described for example in DE 44 41 323. Here each of the carriers can be influenced individually in a specific context, thereby achieving an additional coding. This means that at least one carrier of a multi-carrier system is coded, for example by varying its energy or the energies of certain carriers in relation to each other.

In order to initiate not only a global retransmission of the incorrectly sent data but rather to allow targeted and optimized retransmission, provision can be made for the quality information to be stored and analyzed in the transmitter/receiver device and a repeat transmission of incorrectly transmitted data to proceed on the basis of the result of the analysis. In particular one result of the analysis can be the identification of at least those terminals, which have received incorrect data and a repeat transmission of the incorrectly transmitted data is carried out in a targeted manner to the identified terminals. During the repeat transmission of the data for example a specific adjustment can be made to the modulation (adaptive modulation) an/or the coding and/or the transmission power and/or the spatial beam direction, with which a specific terminal or a specific group of terminals is targeted. This can result in particular in the repeat transmission of the incorrectly transmitted data proceeding on a radio connection, which is assigned clearly to an identified terminal or a group of identified terminals.

The present invention also comprises a radio communication system, which is configured in particular to execute a method as described above and has at least one transmitter/receiver device and a plurality of terminals. The terminals are configured to receive data, which is transmitted by the transmitter/receiver device via a radio connection. According to the invention the radio communication system has devices for providing common transmission capacities for the terminals for the simultaneous transmission of quality information, which contains information about the transmission quality of the transmitted data. In a preferred development the radio communication system can also have devices for storing the quality information and for analyzing the quality information in the sense of identifying at least those terminals, which received incorrect information.

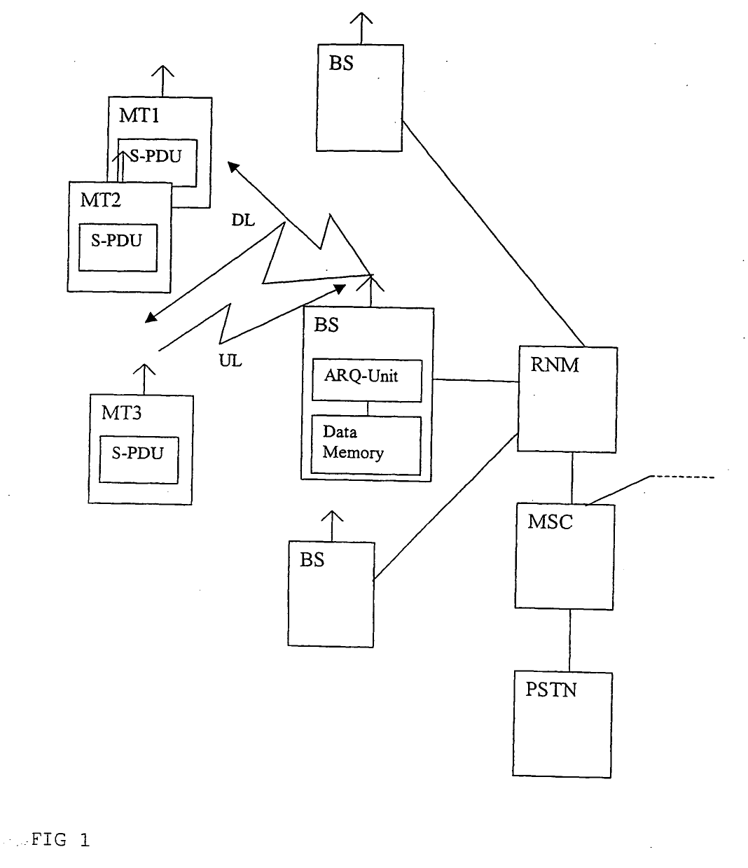

A specific embodiment of the invention is described below using FIGS. 1 to 11.

These show

FIG. 1: Schematic diagram of a radio communication system according to the invention.

FIG. 2: Schematic diagram of a commonly used time slot in a TDMA method for the transmission of quality information by the terminals.

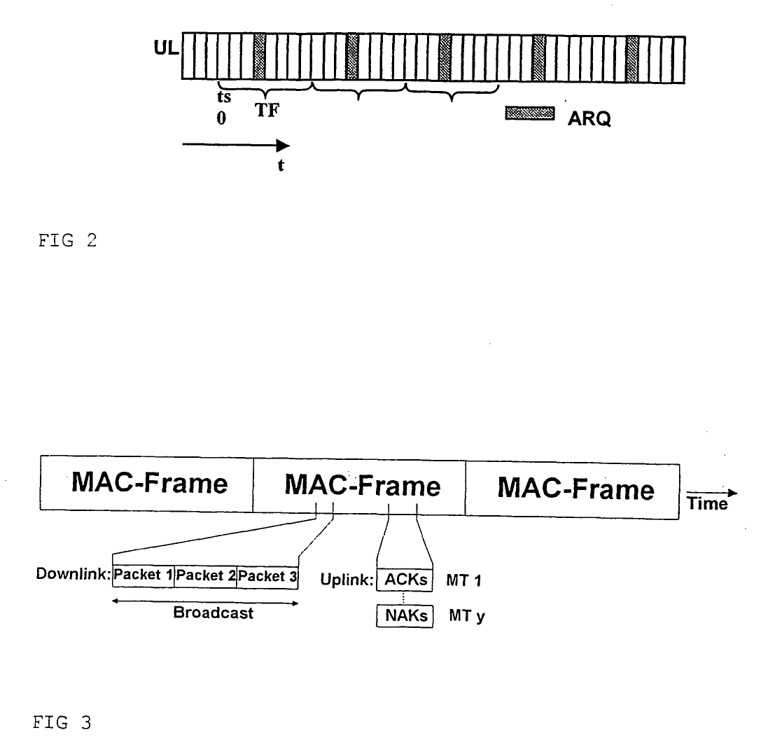

FIG. 3: Diagram of the transmission of data packets and quality information within a time slot framework structure.

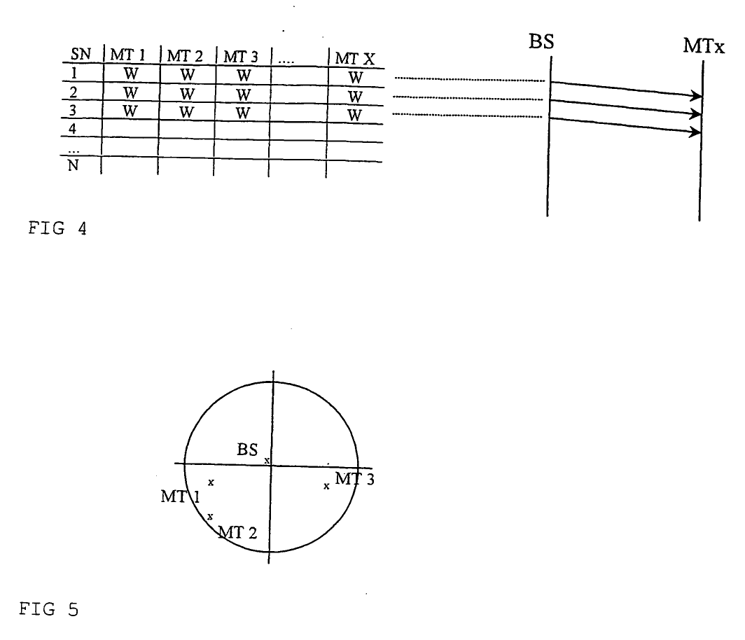

FIG. 4: Diagram of a data table for quality information for the data transmission to X terminals.

FIG. 5: Schematic diagram of a data transmission in the Broadcast method.

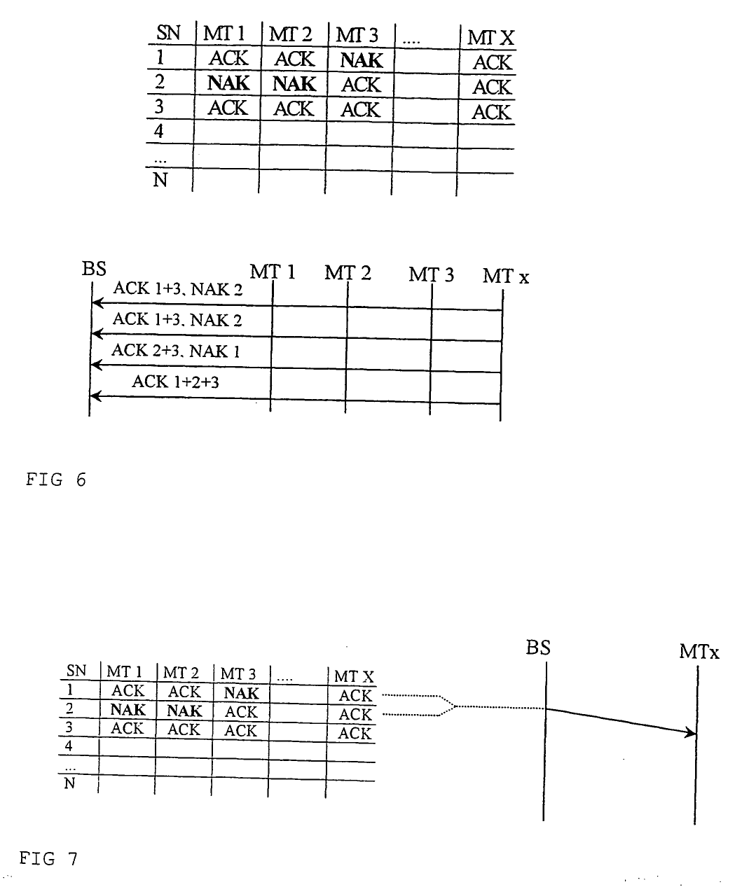

FIG. 6: Diagram of the quality information transmitted back stored in table form.

FIG. 7: Diagram of the retransmission of the data based on the analysis of the stored data table.

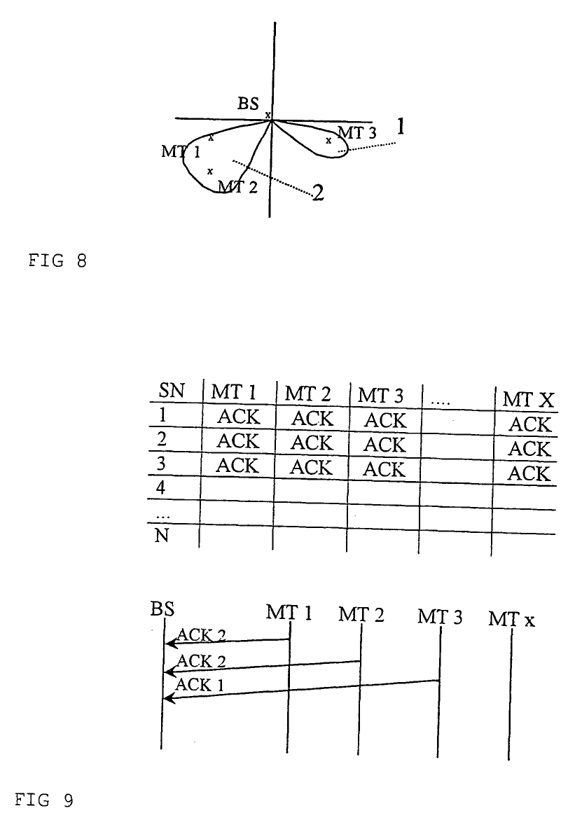

FIG. 8: Schematic diagram of the spatially targeted, repeat transmission of specific data packets.

FIG. 9: Diagram of the repeat feedback transmission of quality information and its storage in the data table.

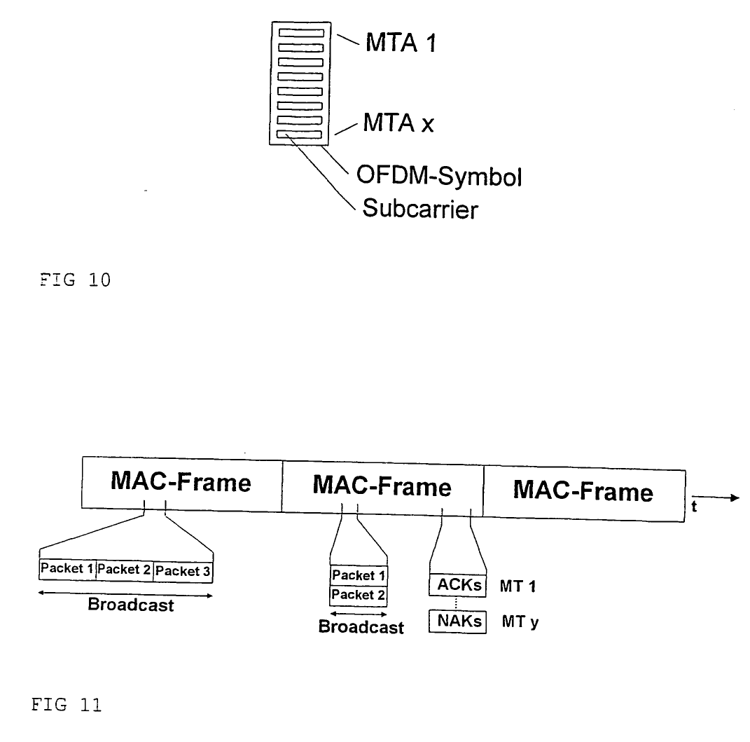

FIG. 10: Schematic diagram of common access by X terminals to a common OFDM symbol for the transmission of quality information.

FIG. 11: Diagram of the transmission of data packets and quality information in the context of an OFDM method.

FIG. 1 shows an example of a radio communication system, which has a plurality of switching devices MSC, which are interconnected. Generally at least one of these switching devices MSC creates access to further communications systems, such as for example a fixed network communication system PSTN. The switching devices MSC are generally connected in such radio communication systems to a device RNM for allocating resources in the radio communication system, to which different base stations BS are connected as transmitter/receiver devices of the radio communication system. The base stations BS are connected via communication connections to terminals, specifically subscriber terminals MT1, MT2, MT3, etc., which can in particular be mobile subscriber terminals MT. The radio communication system is then configured as a mobile radio system.

Between the base station BS and the subscriber terminals MT1, MT2, MT3 in the example according to FIG. 1 there is a bi-directional communication connection with an uplink UL from the subscriber terminals MT1, MT2, MT3 to the base station BS and a downlink DL from the base station BS to the subscriber terminals MT1, MT2, MT3. Parallel identical data is transmitted in the downlink DL from the base station BS to the subscriber terminals MT1, MT2, MT3 and this should arrive as correctly as possible at these terminals. This is therefore a Multicast connection or what it referred to as a point-to-multipoint connection.

FIG. 1 shows a diagram of a device, referred to generally here as an ARQ unit, as a component of the base station BS. In practice this device shown here in the diagram as a unit can comprise one or more suitable devices. The ARQ unit is configured to execute the necessary operations according to the inventive method to achieve an ARQ method with the above-mentioned Multicast connection and to provide the necessary transmission capacities for the corresponding signaling within the base station BS. This device is used in particular to analyze the quality information received from mobile subscriber terminals MT1, MT2, MT3 about the transmission quality of the transmitted data.

Common transmission capacities are provided for simultaneous access by the terminals MT1, MT2, MT3 for the purposes of transmitting quality information in the radio communication system. Such provision can in principle be one of the tasks of the ARQ unit. For example a common time slot can be provided for the terminals MT1, MT2, MT3 as a common transmission unit for the purposes of common transmission capacity in the uplink UL when using a TDMA transmission method. The terminals can then access this time slot as necessary to transmit quality information, for example to transmit a negative acknowledgement, with access being possible by a plurality of terminals simultaneously, if a plurality of terminals have received data incorrectly. Such a time slot ts for the transmission of ARQ quality information within a TDMA time slot framework TF of the uplink UL is shown schematically in FIG. 2. Similarly however a common code of a CDMA method or a common frequency of an FDMA method can be provided.

A further alternative can also be the simultaneous transmission of quality information by means of simultaneous access to spatially separating antennae such as sectorizing antennae or adaptive antennae. Such a spatially separating connection is shown schematically in FIG. 8 and reference is made to this in the context of a targeted retransmission of data below. In the further description the simultaneous transmission of quality information within a common time slot should be assumed.

Bundling the negative acknowledgements NAK at a single time slot means that the data overheads, in other words the signaling costs required to carry out the ARQ method, are restricted on a fixed basis to one time slot, regardless of the number of terminals involved. The probability of sending a NAK increases as the number of receiver terminals increases.

The quality information can be stored in the transmitter/receiver device, which transmitted the data, in the case of FIG. 1 in the base station BS, in a corresponding Data Memory. Such storage can take any suitable form, for example in tables, as set out in more detail below. The stored quality information can then be analyzed and the result of the analysis can be used for the targeted retransmission of incorrectly received data.

The proposed method means that Multicast or Broadcast services can be set up with little probability of residual error and extremely low data overheads. The method can be used to ensure that repeat transmission of incorrectly transmitted data can be executed, once a terminal has received a specific data packet incorrectly.

In the example according to FIG. 3 N data packets packet 1, packet 2, packet 3, . . . are transmitted from a base station BS in a Broadcast method to X receiver terminals MT1, MT2, MT3 to MTX, as also shown schematically in FIG. 5. In the context of the transmission of data, a data table is created in the base station—in the Data Memory—as shown in FIG. 4—for the storage of quality information. In the table X columns are provided for the X terminals MT1 to MTX and N rows for the N transmitted data packets with the ARQ protocol sequence numbers (serial numbers SN) 1 to N. The figures in the table can initially be freely selected, e.g. have an initial value W=waiting. In the present example it is assumed that in each case quality information is transmitted back to the base station, i.e. both positive and negative acknowledgements are transmitted, depending on whether the data transmission was correct or incorrect.

For example the terminals MT1 and MT2 have now received the data packet Packet2 incorrectly while the terminal MT3 received the data packet Packet1 incorrectly. All the other data packets were received correctly. As a result the corresponding positive acknowledgements (ACK) and negative acknowledgements (NAK) are transmitted from the terminals MT1 to MTX to the base station BS and stored accordingly in the table filed there, as shown schematically in FIG. 6. The feedback transmission of the acknowledgements can be simultaneous as already described. Terminals MT1 and MT2 in particular then confirm the correct receipt of data packets Packet1 and Packet3 and the incorrect receipt of data packet Packet2. Terminal MT3 accordingly confirms the correctness of the data packets Packet2 and Packet3 and the incorrect transmission of Packet1.

As shown in FIG. 7 it is only possible to determine which data packets were transmitted incorrectly and have to be transmitted again from the base station by means of an analysis of the stored table. This repeat transmission can in principle also proceed in a Broadcast method according to FIG. 5 but can also proceed using a targeted manner based on the precise knowledge of which terminals have to receive which data packets again, as shown in FIG. 8. Spatially targeted retransmission (references 1 and 2) of the data packets to the terminals MT1, MT2 and MT3 proceeds here, for example by means of sectorized antennae or adaptive antennae. The terminals MT1 and MT2 can be combined in a group, subject on a common basis to a targeted retransmission (reference 2) of the data packet Packet2. On the other hand the data packet Packet1 is transmitted in a targeted manner to the terminal MT3 (reference 1) regardless of this. Quality information about the transmission quality in the form of acknowledgements from the terminals MT1, MT2, MT3 is in turn sent back to the base station, with the correct receipt of the retransmitted data packets being confirmed in the example according to FIG. 9 and the corresponding information being input into the data table (FIG. 9).

The present method can specifically be used in multi-carrier systems such as systems based on the OFDM method. Here the simultaneous transmission of negative acknowledgements is problem-free, in particular guaranteed by the guard interval provided for with OFDM, which compensates for multipath propagation. Any rerouting delay times can therefore be compensated for by the guard interval with OFDM. This principle is used for example in continuous wave radio. FIG. 10 shows such a simultaneous transmission of a number of acknowledgements within an OFDM symbol in schematic form, with one terminal MT1 to MTX accessing one subcarrier of the OFDM symbol in each instance. This is also shown again schematically in FIG. 11. With such an OFDM method the data packets Packet1, Packet2, Packet3 can also be transmitted either consecutively or in parallel, as shown in FIG. 11. In principle it is conceivable for the subcarriers of an OFDM symbol to be distributed to different packets for the parallel transmission of a number of packets, so that one part of each subcarrier is assigned to a specific packet. It has been common practice to date for example for only identical data packets to be sent out simultaneously from a plurality of transmitter/receiver devices and received at one terminal (SFN). However a parallel transmission can also proceed by means of an additional spatial separation of the transmission, as shown in FIG. 8, i.e. in particular by means of sectorizing or adaptive antennae. This allows a spatially separate, simultaneous transmission of packets to different terminals at different spatial locations, in particular within the same time slot. For example, for small quantities of data, as also occur with the acknowledgements to be transmitted, allocation can be made to a part of the subcarrier and spatially separating antennae can be used for simultaneous transmission, while with large quantities of data spatially separating antennae tend to be used for simultaneous transmission. If different subcarriers are to transmit different information, this can be used in particular for the transmission of binary information, e.g. 1=ACK, 0=NAK. Different subcarriers can then be assigned to different transmitters, which then transmit the corresponding information on the respective subcarrier.

If now for example, when transmitting data in the form of data packets, a plurality or even all the terminals send back the same acknowledgement (NAK) to the transmitter after incorrect receipt of a specific data packet and request the last data packet again, the transmitter can receive this acknowledgement (NAK) correctly in any case, even though the message was sent from a plurality of stations.

To increase the information content of the negative acknowledgement (NAK) the subcarriers of an OFDM symbol can also be used in a different manner, by supplying them with different energy. This results in an additional coding. Supplying different energy to the subcarriers allows simple determination of the additional information content of the acknowledgement to the transmitter/receiver device as recipient of the acknowledgement, even if a plurality of—in some cases only partially synchronized—terminals have transmitted such information. The additional information can for example be used to identify the incorrectly received data packets clearly.

In this way for example energy can be supplied to all the straight carriers of an OFDM symbol, if the last transmitted data packet was received incorrectly and all non-straight subcarriers if the penultimate packet was not received correctly. So instead of what is known as a stop-and-go ARQ method, in which only the last received data packed is acknowledged in each instance, a go-back-N ARQ method could be used, which allows acknowledgement of the last N data packets received. This requires lower signaling expenditure, i.e. the data overheads can be further reduced.

Provision can also be made for the time slot for the transmission of a negative or positive acknowledgement to be only half as long as the time slot for the transmission of useful data in the uplink.

The positive effects of the proposed method are set out briefly below. Half as long a time slot for the transmission of acknowledgements is assumed here as for the transmission of useful data. For a Multicast group size of 13 stations (12 receiver terminals) the data overheads for a conventional ARQ method would be 6/1, while the data overheads for the proposed method are reduced to 0.5/1.

To summarize, it can be established that with the proposed method instead of an amplified FEC without ARQ, the proposed ARQ method can be used for further optimization, in combination where necessary with a standard FEC, to reduce transmission errors. This measure allows a significantly more efficient use of the available transmission capacity.

1. Method for the parallel transmission of identical data (Packet 1, Packet 2, Packet 3) from a transmitter/receiver device (BS) to a plurality of terminals (MT1, MT2, MT3), with the transmission between the transmitter/receiver device (BS) and the terminals (MT1, MT2, MT3) proceeding at least partially via a radio
connection,
characterized in that
after receipt of the parallel transmitted identical data (Packet 1, Packet 2, Packet 3), quality information (ACK, NAK) about the transmission quality of the data (Packet 1, Packet 2, Packet 3) is sent back from the terminals (MT1, MT2, MT3) to the transmitter/receiver device (BS), with common transmission capacities (ts; 1, 2; OFDM symbol) being made available to the terminals (MT1, MT2, MT3) in the context of the radio connection for transmission of the quality information (ACK, NAK) from a plurality of terminals (MT1, MT2, MT3) to the transmitter/receiver device (BS).

2. Method according to claim 1,
characterized in that quality information (ACK, NAK) at least is then sent back to the transmitter/receiver device (BS), if part of the data (Packet 1, Packet 2, Packet 3) has been transmitted incorrectly.

3. Method according to claim 1 or 2,
characterized in that after receipt of data (Packet 1, Packet 2, Packet 3) from the terminal (MT1, MT2, MT3), quality information (ACK, NAK) is sent back continuously to the transmitter/receiver device (BS), containing information about which data (Packet 1, Packet 2, Packet 3) was transmitted incorrectly and which correctly.
characterized in that
simultaneous transmission of the quality information (ACK, NAK) proceeds by means of spatial separation of the quality information (ACK, NAK) sent back, using spatially separating receiver components in the transmitter/receiver device (BS).

5. Method according to claim 4,
characterized in that
spatial separation is achieved using sectorizing antennae or adaptive antennae.

6. Method according to one of claims 1 to 3,
characterized in that
simultaneous transmission of the quality information (ACK, NAK) proceeds by means of simultaneous access by the terminals (MT1, MT2, MT3) to at least one common transmission unit of the radio connection to the transmitter/receiver device (BS).

7. Method according to claim 6,
characterized in that
simultaneous access is achieved to at least one common frequency of a frequency multiplex radio connection, at least one common time slot of a time multiplex connection or at least one common code of a code multiplex connection.

8. Method according to one of claims 6 or 7,
characterized in that
the information transmitted in the context of the transmission unit is coded for the clear identification of the terminals (MT1, MT2, MT3) and/or the incorrectly transmitted data (Packet 1, Packet 2, Packet 3).

9. Method according to claim 8,
characterized in that
coding is achieved by varying the physical properties, for example the energy, frequency or duration of the carrier signals of the radio connection to the transmitter/receiver unit (BS) during the transmission unit.

10. Method according to one of claims 8 or 9,
characterized in that
at least one carrier of a multi-carrier method is coded.

11. Method according to one of claims 1 to 10,
characterized in that
the quality information (ACK, NAK) is stored and analyzed in the transmitter/receiver device (BS) and a repeat transmission of incorrectly transmitted data (Packet 1, Packet 2, Packet 3) proceeds on the basis of the result of the analysis.

12. Method according to claim 11,
characterized in that
as one result of the analysis identification is provided of at least those terminals (MT1, MT2, MT3), which received incorrect data (Packet 1, Packet 2, Packet 3), and a repeat transmission of the incorrectly transmitted data (Packet 1, Packet 2, Packet 3) proceeds in a targeted manner to the identified terminals (MT1, MT2, MT3).

13. Method according to one of claims 11 or 12,
characterized in that
the repeat transmission of the incorrectly transmitted data (Packet 1, Packet 2, Packet 3) proceeds on a radio connection, which is clearly assigned to an identified terminal (MT1, MT2, MT3) or a group of identified terminals (MT1, MT2, MT3).

14. Radio communication system with at least one transmitter/receiver device (BS) and a plurality of terminals (MT1, MT2, MT3), which are configured to receive parallel transmitted identical data (Packet 1, Packet 2, Packet 3), which is transmitted by the transmitter/receiver device (BS) via a radio connection,
characterized in that
the radio communication system has devices for supplying common transmission capacities (ts; 1, 2; OFDM symbol) for the terminals (MT1, MT2, MT3) for the transmission of quality information (ACK, NAK), containing information about the transmission quality of the parallel transmitted identical data (Packet 1, Packet 2, Packet 3).

15. Radio communication system according to claim 14,
characterized in that
the radio communication system has devices (Data Memory, ARQ Unit) for storing the quality information (ACK, NAK) and for analyzing the quality information in the sense of identifying at least those terminals (MT1, MT2, MT3), which received incorrect data (Packet 1, Packet 2, Packet 3).
